(19) United States
(12) Patent Application Publication
(10) Pub. No.: US 2011/0122320 A1
(43) Pub. Date: May 26, 2011

(54) BROADCAST CONTENTS DATA TRANSMITTING APPARATUS AND CONTENTS DATA TRANSMITTING METHOD

(76) Inventors: Shuichi YAMAGUCHI, Kunitachi-shi (JP); Kenshi Dachiku, Kawasaki-shi (JP)

(21) Appl. No.: 12/850,757

(22) Filed: Aug. 5, 2010

(30) Foreign Application Priority Data
Nov. 25, 2009 (JP) 2009-267818

(51) Int. Cl. H04N 5/268

(52) U.S. Cl. 348/705; 348/E05.057

(57) ABSTRACT

According to one embodiment, a broadcast contents data transmitting apparatus includes a switcher, transmission-side processors and reception-side processors. The transmission-side processor includes a transmitter is configured to transmit the contents data stored in the recording medium to the switcher, as data units smaller than one data block that is a management unit of contents data. The switcher includes a transmission buffer configured to store the contents data transmitted from the transmission-side processor and to transmit the contents data to the reception-side processor.

### CROSS-REFERENCE TO RELATED APPLICATIONS

This application is based upon and claims the benefit of priority from Japanese Patent Application No. 2009-267818, filed Nov. 25, 2009; the entire contents of which are incorporated herein by reference.

### FIELD

Embodiments described herein relate generally to a broadcast contents data transmitting apparatus and a contents data transmitted method, both designed to transmit the contents data of broadcast programs.

### BACKGROUND

As known in the art, in any system for transmitting broadcast programs, the contents data of any broadcast program are stored in a transmission server, and any contents data designated is first reproduced and delivered toward transmitter or other equipment in accordance with an instruction from an broadcast program distribution controller. In the on-air process, the materials are confirmed in the order they will be put on air, in most cases.

The conventional transmission server uses a shaped-type bus to transmit materials. Now, more and more materials must be transmitted for longer distances than before. A network for general use, such as Ethernet (trademark) may be used to transmit materials. If many video data items are output through the Ethernet, however, a packet loss will inevitably occur because of buffer overflow.

Prior-art techniques related to material transmission includes a method of transmitting data items of a group, each dispersed from another, through a group of physical lines (see, for example, WO2004/051955), and a method of transmitting data in the form of packets (see, for example, Jpn. Pat. Appln. KOKAI Publication No. 2004-32225). In these methods, however, video data is not switched in units of frames.

### BRIEF DESCRIPTION OF THE DRAWINGS

FIG. 1 is a block diagram showing a broadcast program transmitting system to which an embodiment is applied;

FIG. 2 is a block diagram sowing the configuration of a video server according to one embodiment;

FIG. 3 is a diagram illustrating, in detail, how a packet is transmitted in the process of outputting video data from a video data input/output unit in the embodiment;

FIG. 4 is a diagram illustrating how video data is transmitted from a plurality of video data input/output units in the embodiment;

FIG. 5 is a diagram illustrating how video data is transmitted in the embodiment if the transmission speed differs in accordance with the input/output port used in a network transmission unit;

FIG. 6 is a diagram illustrating how to transmit more video data items from the system at the same time;

FIG. 7A is a sequence diagram illustrating the sequence of transmitting video data in the video data input/output unit in the embodiment;

FIG. 7B is a sequence diagram illustrating the sequence of decoding video packets to video signals in the video decoding units in the embodiment; and

FIG. 8 shows the structure of an MXF file.

### DETAILED DESCRIPTION

In general, according to one embodiment, a broadcast contents data transmitting apparatus includes a switcher, transmission-side processors and reception-side processors. The switcher is configured to switch a plurality of input/output transmission paths, from one to another. The transmission-side processor is connected to input transmission paths of the switcher and is configured to store contents data representing broadcast programs in a recording medium. The reception-side processor is connected to output transmission paths of the switcher and is configured to receive the contents data transmitted from the transmission-side processor. The transmission-side processor includes a transmitter is configured to transmit the contents data stored in the recording medium to the switcher, as data units smaller than one data block that is a management unit of contents data. The switcher includes a transmission buffer configured to store the contents data transmitted from the transmission-side processor and to transmit the contents data to the reception-side processor.

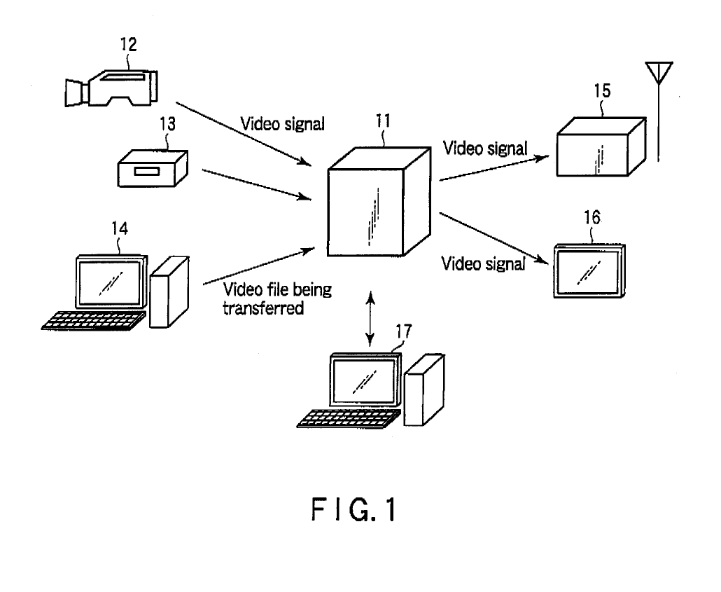

FIG. 1 is a block diagram showing a broadcast program distribution system to which an embodiment is applied. In FIG. 1, number 11 designates a video server. The video server 11 stores contents data of broadcast programs, supplied from a camera 12, a playback deck 13 and a nonlinear editor 14. The contents data (herein after called “video data”) will be put to on-air process. The video server 11 reproduces any selected video data item, in accordance with an on-air instruction associated with the video data item. The video data item thus reproduced is decoded in the video server 11, is supplied to the broadcasting equipment 15 or other equipment. The video data item is supplied to a monitor 16.

Further, the video server 11 controls the writing and reading of the video data, in accordance with the operating instruction input at a console terminal 17.

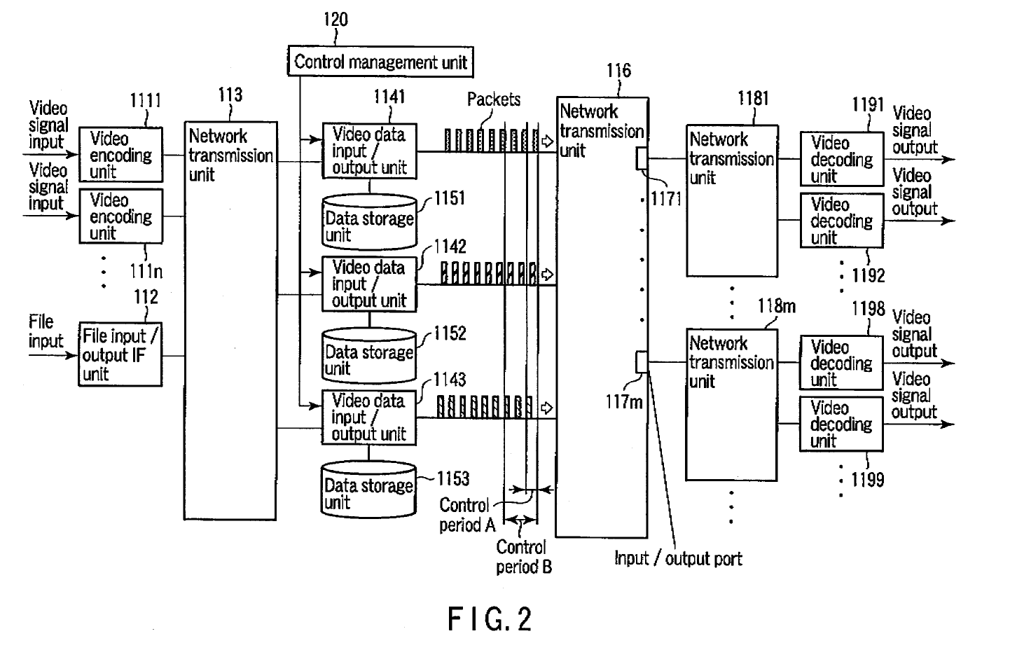

FIG. 2 is a block diagram sowing the configuration of the video server 11 according to one embodiment.

The video server 11 has a plurality of video encoding units 1111 to 111n, a file input/output interface unit 112, a network transmission unit 113, a network transmission unit 116, network transmission units 1181 to 118m, data storage units 1151 to 1153, video data input/output units 1141 to 1143, a plurality of video decoding units 1191 to 1199, and a control management unit 120. The video encoding units 1111 to 111n encode video signals of, for example, high definition-serial digital interface (HD-SDI) type, in, for example, Moving Picture Experts Group 2 (MPEG2) scheme. The file input/output interface unit 112 receives encoded file data. The network transmission units 113, 116 and 1181 to 118m transmit encoded video data. The data storage units 1151 to 1153 store video data. The video data input/output units 1141 to 1143 serve as transmission-side processors, receiving the video data coming via a network and supplying the same to the data storage units 1151 to 1153. The video decoding units 1191 to 1199 serve as reception-side processors, decoding the video data coming from the video data input/output units 1141 to 1143. The control management unit 120 causes the video data input/output units 1141 to 1143 to operate in synchronism and to output video data in units of frames (control period B).

This embodiment is concerned mainly with the prevention of a packet loss and the playback control of video data in the course of transmitting the video data from the video data input/output units 1141 to 1143 to the video decoding units 1191 to 1199 through the network transmission unit 116 and network transmission units 1181 to 118m. In the embodiment, any video data output as packet from the video data input/output units 1141 to 1143 has two control units, i.e., control period A and control period B. The embodiment is based on the assumption that the network transmission unit 116 and network transmission units 1181 to 118m are constituted by, for example, Ethernet switches.

Of these network transmission units, the network transmission unit 116 incorporates as many output buffers 1171 to 117m as the output ports used in the system.

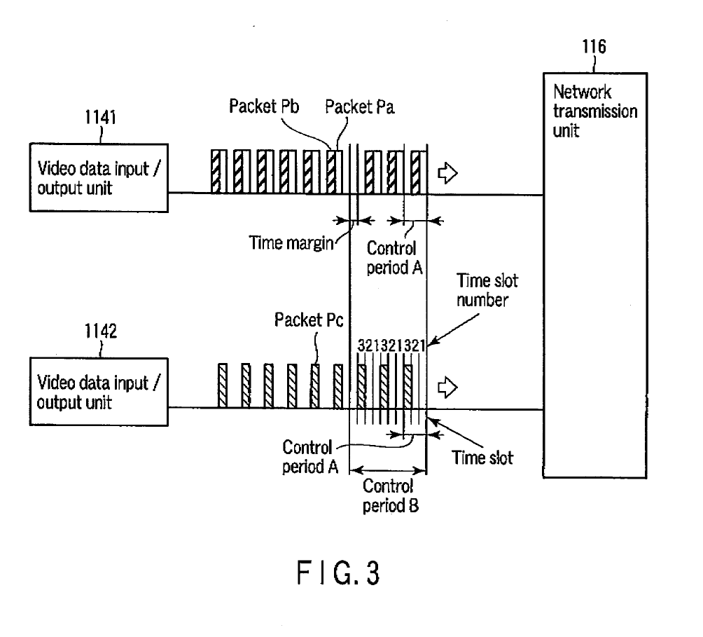

FIG. 3 is a diagram illustrating, in detail, how a packet is transmitted in the process of outputting video data from, for example, the video data input/output units 1141 and 1142. Of the two control units mentioned above, the control period A has a structure of a time slot and is used to transmit the video data in the form of small units, in order to avoid a packet loss. The network transmission unit 116 cannot achieve clock synchronization between the input/output ports, because it is constituted by an Ethernet switch. Consequently, no time slot synchronization can be accomplished between the video data input/output units 1141 and 1142.

The video data input/output units 1141 and 1142 therefore perform time slot management, independently of each other, in order to achieve data transmission. That is, the video data input/output unit 1141 coverts the video data to video packets Pa and Pb, which are transmitted to the network transmission unit 116. Time slots numbers “1” and “2” are inserted in the headers of the video packets Pa and Pb, respectively. Meanwhile, the video data input/output unit 1142 converts the video data to a vide packet Pc, which is transmitted to the network transmission unit 116. In the header of this video packet Pc, time slot number “3” is inserted.

In this embodiment, the control period B performs data control that may be achieved by a plurality of control periods A. The control period B is a transmission control unit for managing contents data such as video data. In the present embodiment, the control period B is associated with the image frames.

The video data input/output units 1141 and 1142 perform synchronization in response to a control command the control management unit 120 makes for every control period B. However, the precision of this synchronization is limited by the operating precision of the network transmission unit 116. This is why the control period B has a time margin for the switching the transmission of vide data items.

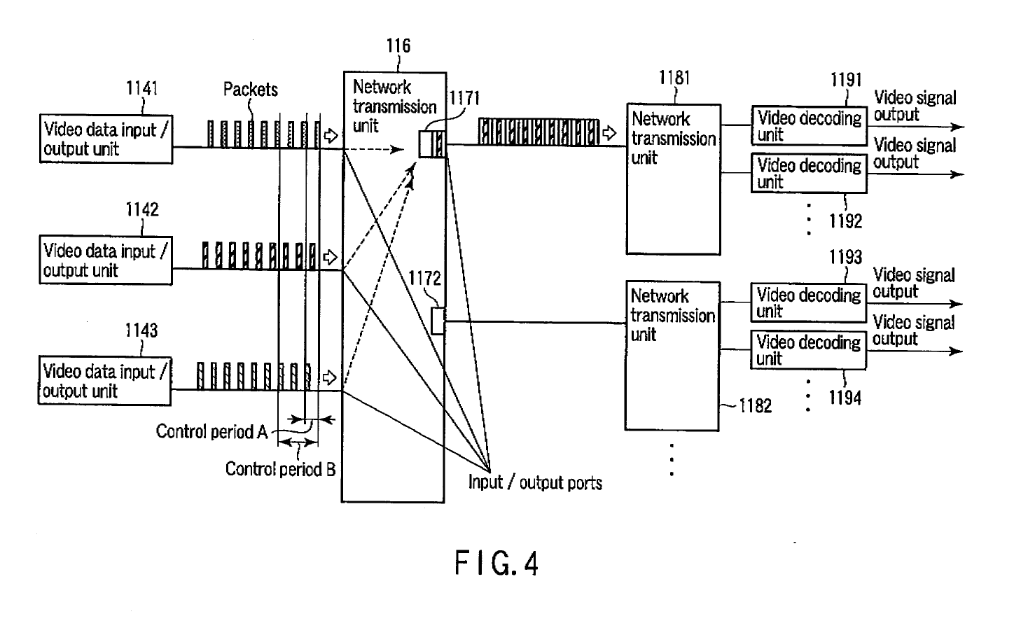

FIG. 4 is a diagram illustrating how video data is transmitted from the video data input/output units 1141 and 1143. More precisely, FIG. 4 shows the case where the video data input/output units 1141 and 1143 transmit three kinds of video data items, respectively. The video data input/output units 1141 and 1143 transmit these video data items allocated to the time slots of the control period A, respectively. In the network transmission unit 116, transmission clock signals are not synchronized between the input/output ports, and synchronization cannot be achieved between the video data input/output units 1141 to 1143. Hence, even if the vide data is divided into time slots, packets may simultaneously arrive at the network transmission unit 116. In this case, a packet loss will occur if the output buffers 1171 to 117m provided at the input/output ports, respectively, receive more packets arrive than they can store, inevitably causing buffer overflow. This is because the data transmitting ability of each input/output port is limited even if the network transmission unit 116 has sufficient packet routing ability.

In view of this, the control period A is so small that fewer packets are transmitted between control periods A, than all packets that can be stored in the output buffers 1171 to 117m of the network transmission unit 116. This avoids buffer overflow even if packets arrive, one overlapping any other.

The control management unit 120 controls the video data input/output units 1141 to 1143 for control period B. Therefore, the control management unit 120 controls the video data input/output units 1141 to 1143, fewer times than otherwise. Further, control period B is associated with the image frames, whereby the video data can be controlled in units of frames that are smallest units of video data finally output.

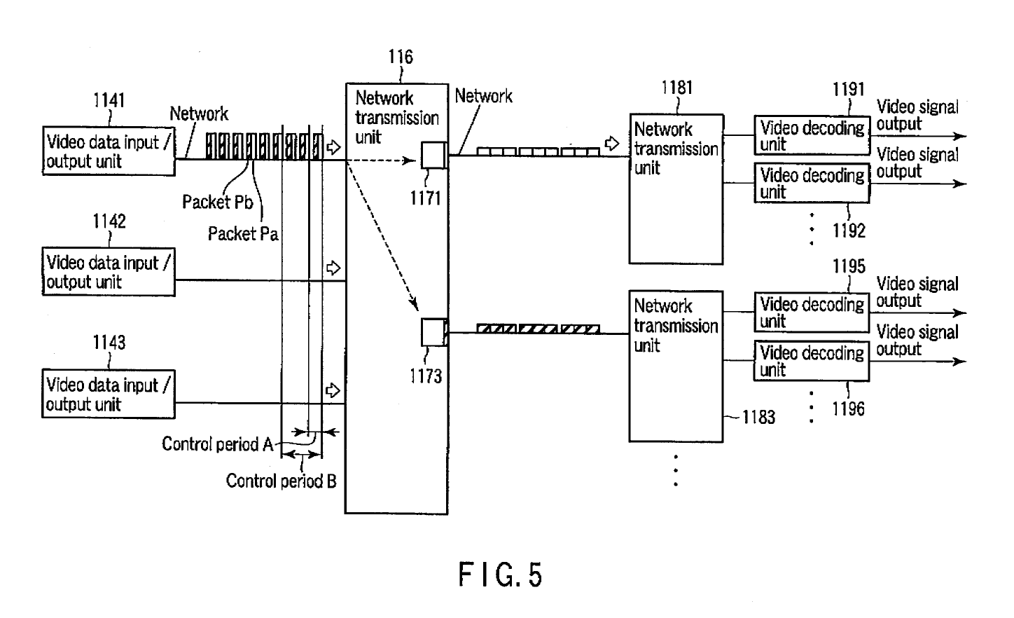

FIG. 5 is a diagram illustrating how video data is transmitted in the embodiment if the transmission speed differs in accordance with the input/output port used in the network transmission unit 116.

Assume that data is transmitted from the video data input/output units 1141 to 1143 to the network transmission unit 116 at a low speed, and that data is transmitted from the network transmission unit 116 to the network transmission units 1181 to 1183 at a low speed, too. Then, the control management unit 120 manages the output video data in accordance not only with the size of the control period A that accords with the storage capacities of the output buffers 1171 and 1173, but also with the low transmission speed of the network. In this case, the video packets Pa and Pb transmitted from the video data input/output unit 1141 are stored in the output buffers 1171 and 1173 of the network transmission unit 116, respectively. Of the video packets Pa stored in the output buffer 1171, three packets Pa are transmitted, as a set, to the network transmission unit 1181. Of the video packets Pb stored in the output buffer 1173, three packets Pb are transmitted, as a set, to the network transmission unit 1183.

The data is thus managed, not exceeding the upper limit of band in any network used, and smoothing the transmission band by using time slots to transmit data. As a result, peak bands lasting a short time are suppressed, preventing a packet loss.

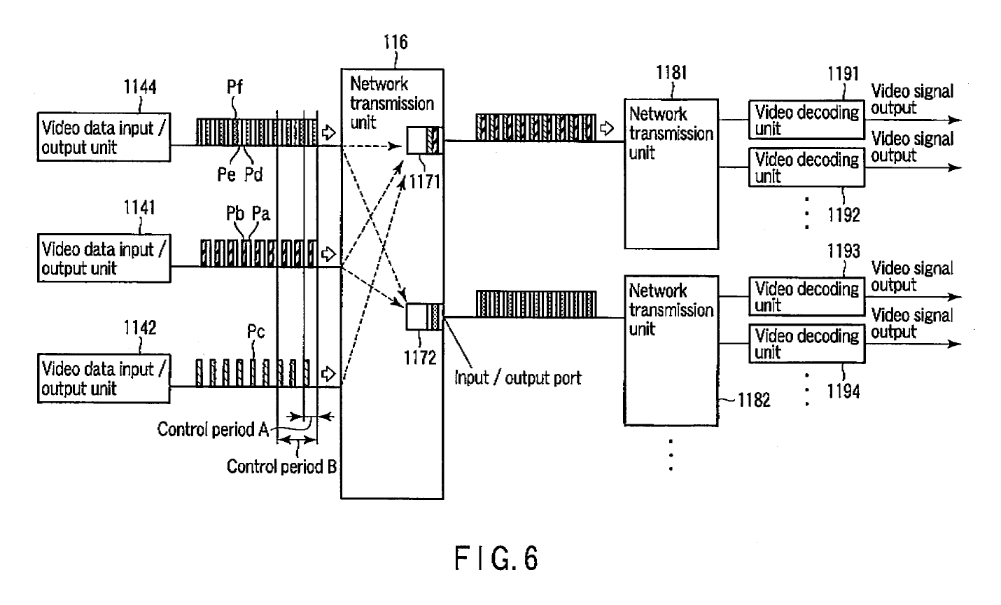

FIG. 6 is a diagram illustrating how to transmit more video data items from the system at the same time. In this case, data is transmitted to and from the network transmission unit 116 at the same speed in the network, and the number of video data items output is managed as shown in FIG. 5. The video data input/output units 1141, 1142 and 1144 allocate the video data items to the same time slot, whereby more video data items are simultaneously output than otherwise.

In this case, the video data items can be transmitted without overflowing the output buffer 1171 or 1172 though they are allocated to the same time slot, only if they are transmitted through different input/output ports, or not through the same network. Hence, a packet loss due to buffer overflow can be avoided.

That is, the video packets Pa transmitted from the video data input/output unit 1141 are stored in the output buffer 1172 of the network transmission unit 116, and the video packets Pb transmitted from the video data input/output unit 1141, too, are stored in the output buffer 1171 of the network transmission unit 116. The video packets Pc transmitted from the video data input/output unit 1142 are stored in the output buffer 1171 of the network transmission unit 116. Further, the video packets Pd transmitted from the video data input/output unit 1144 and allocated to the same time slot number as the video packets Pa are stored in the output buffer 1171, the video packets Pe allocated to the same time slot number as the video packets Pb are stored in the output buffer 1172, and the video packets Pf allocated to the same time slot number as the video packets Pc are stored in the output buffer 1172.

The video packets Pd, Pb and Pc stored in the output buffer 1171 are transmitted, as a set of Pd+Pb+Pc, to the network transmission unit 1181. On the other hand, the video packets Pe, Pf and Pe stored in the output buffer 1172 are sent, a set of Pe+Pf+Pa, to the network transmission unit 1182.

In any embodiment thus far described, errors over packets are corrected by using Read-Solomon codes in order to prevent a packet loss. The time slots therefore disperse the video packets along the time axis. This renders the system resistant to burst errors resulting from, for example, external noises.

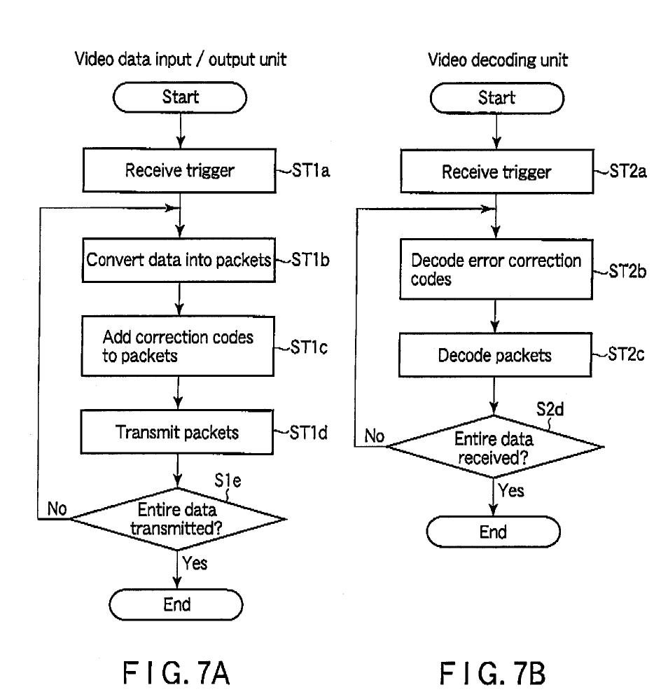

The operation of the video server 11 configured as described above will be explained with reference to FIG. 7. FIG. 7A is a sequence diagram illustrating the sequence of transmitting video data in the video data input/output unit 1141. FIG. 7B is a sequence diagram illustrating the sequence of decoding video packets to video signals in the video decoding units 1191.

The video data input/output unit 1141, for example, remains ready to transmit video data. In this state, the video data input/output unit 1141 receives a transfer trigger from the control management unit 120 (Step ST1a). On receiving the transfer trigger, the video data input/output unit 1141 divides the one-frame video data stored in the data storage unit 1151 into video packets, and adds headers, each describing an address and a time slot, to the video packets, respectively (Step ST1b). Further, the video data input/output unit 1141 adds error correction codes to the video packets, respectively (Step ST1c). The video data input/output unit 1141 then transmits the video packets to the network transmission unit 116 (Step ST1d). While dividing the one-frame video data into video packets, the video data input/output unit 1141 generates a table showing, for example, channel numbers, head time codes and material lengths, and stores this table in the data storage unit 1151. Further, if the video data has the group of pictures (GOP) structure, the video data input/output unit 1141 divides not only the one-frame video data, but also the material length (total frame number) into GOP frame numbers. That is, the first of the N frames constituting the video data becomes the head GOP frame. The head GOP frame is stored in the data storage unit 1151.

The transmission process described above is repeated until it is determined in Step ST1e that the entire video data has been transmitted.

Meanwhile, the video decoding unit 1191, for example, remains ready to receive video data. In this state, the video decoding units 1191 receives a transfer trigger (Step ST2a). On receiving the transfer trigger, the video decoding units 1191 decodes error correction codes in accordance with the error correction codes added to the video packets transmitted from the video data input/output unit 1141 (Step ST2b). The video decoding units 1191 then decodes the video packets to video signals (Step ST2c). This reception process is repeated until it is determined in Step ST2d that the entire video data has been received.

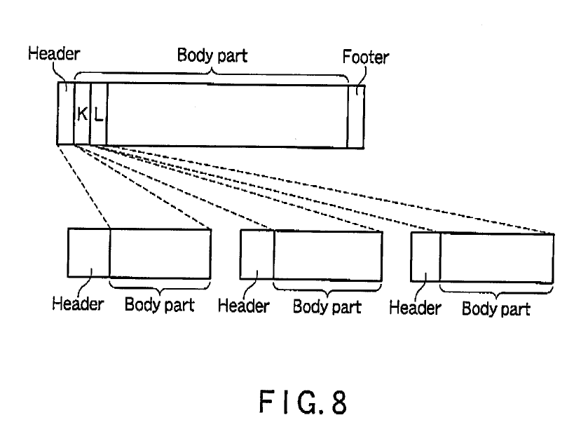

An MXF file input to the file input/output interface unit 112 is sent to, for example, the video data input/output unit 1144. FIG. 8 shows the structure of the MXF file. As shown in FIG. 8, the MXF file is composed of a header, a body part and a footer. The header has a fixed length and starts with, for example, the start code of a fixed pattern. The body part includes video data audio data. It further includes key data identifying the image and sound represented by the video data and audio data, respectively, and also length data defining the length of video data and that of the audio data. The footer ends with, for example, the end code of a fixed pattern. In FIG. 8, K is the key data, L is the length data.

Before dividing one MXF file into packets, the video data input/output unit 1144 generates a tale showing, for example, channel numbers, head time codes and material lengths, and stores this table in the data storage unit 1154. Headers, each including a time slot number and an address, are added to the packets obtained by dividing the MXF file. The body part of each packet contains an MXF segment. The body part of the first packet contains the header of the MXF file.

In the embodiment described above, the video data input/output units 1141 to 1143 transmit the video data items stored in the data storage units 1151 to 1153 to the network transmission unit 116, in units of video packets, each being smaller than one frame. This prevents a packet loss that may result if data overflows the output buffers 1171 to 117m of the network transmission unit 116.

In the embodiment described above, the control management unit 120 does not synchronize the outputting of video data items from the video data input/output units 1141 to 1143. Rather, the video data is controlled, only in units of frames. This helps to reduce the number of times the control is performed.

The video data input/output units 1141 to 1143 saves the head positions of the frames when the video data items are stored in the data storage units 1151 to 1153. Hence, the head position of each frame can be utilized to provide a response time during the transmission control.

Moreover, in the embodiment described above, a packet loss can be avoided in the network transmission unit 116 even if the networks have different transmission speeds.

In the embodiment described above, the video decoding units 1191 to 1199 can process the video packets transmitted from the video data input/output units 1141 to 1143, based on the time slot numbers, thereby eliminating the time difference between the video packets.

Further, a data loss can be prevented at the time of switching the transmission of one video data item to that of another video data item, though no synchronization is achieved between the input/output ports of the network transmission unit 116. This is because the control management unit 120 sets a time margin for the switching the frames (control period B) of video data transmission of vide data items in the course of transmitting the video data.

Still further, in the embodiment described above, the error correction codes are inserted between the video packets to transmit. Therefore, the system is more resistant to burst errors, than otherwise.

The control period B accords to the video frames in the embodiment described above. Instead, the control period B may be accord to data blocks that are units of video material, which are managed one by one.

The video server 11 need not be limited to the configuration shown in FIG. 2. For example, the video data input/output units 1141 to 1143 and the video decoding units 1191 to 1199 can be changed in number as needed. The sequence of transmitting video data items and each step of the data transmission can be changed in various ways.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A broadcast contents data transmitting apparatus comprising:
a switcher configured to switch a plurality of input/output transmission paths, from one to another;
transmission-side processors connected to input transmission paths of the switcher and configured to store contents data representing broadcast programs in a recording medium; and
reception-side processors connected to output transmission paths of the switcher and configured to receive the contents data transmitted from the transmission-side processor,
wherein the transmission-side processor includes a transmitter configured to transmit the contents data stored in the recording medium to the switcher, as data units smaller than one data block that is a management unit of contents data, and the switcher includes a transmission buffer configured to store the contents data transmitted from the transmission-side processor and to transmit the contents data to the reception-side processor.

2. The broadcast contents data transmitting apparatus according to claim 1, further comprising a controller configured to synchronize transmission-side processors connected to the input transmission paths of the switcher, respectively, and perform transmission control in units of data blocks.

3. The broadcast contents data transmitting apparatus according to claim 2, wherein the controller performs the transmission control in accordance with a frame cycle of the video data transmitted by the transmission-side processor.

4. The broadcast contents data transmitting apparatus according to claim 1, wherein each of the transmission-side processors holds the head position of the data block when the contents data is stored in the recording medium.

5. The broadcast contents data transmitting apparatus according to claim 2, wherein the controller causes the transmission-side processor to transmit the contents data in units of time slots, and allocates, to the time slots, the contents data stored in the recording medium at the transmission speed of the transmission paths connecting the reception-side processor, when transmission paths connecting the transmission-side processor and transmission paths connecting the reception-side processor include different transmission speeds.

6. The broadcast contents data transmitting apparatus according to claim 2, wherein the controller causes the transmission-side processors to transmit contents data in units of time slots, and allocates, to the same time slot, the contents data transmitted by the transmission-side processors.

7. The broadcast contents data transmitting apparatus according to claim 2, wherein the controller provides a time margin between any adjacent data blocks in order to avoid a data loss when the switcher switches the transmission of the contents data.

8. The broadcast contents data transmitting apparatus according to claim 1, wherein the transmitter sets an error correction code between any adjacent contents data items to transmit.

9. The broadcast contents data transmitting apparatus according to claim 1, wherein the transmitter transmits the contents data stored in the recording medium to the switcher in unit of packets that is each smaller than one video frame.

10. A data transmitted method for use in a broadcast contents data transmitting apparatus including a switcher configured to switch a plurality of input/output transmission paths, from one to another; transmission-side processors connected to input transmission paths of the switcher and configured to store contents data representing broadcast programs in a recording medium; and reception-side processors connected to output transmission paths of the switcher and configured to receive the material data transmitted from the transmission-side processors, the method comprising:
transmitting the contents data stored in the recording medium to the switcher, as data units smaller than one data block that is a management unit of contents data, by using the transmission-side processor; and
storing the contents data transmitted from the transmission-side processors in a transmission buffer provided for an output transmission path of the switcher and transmitting the contents data from via the switcher to the reception-side processors.
